(19) United States
(12) Patent Application Publication
(10) Pub. No.: US 2011/0217031 A1
(43) Pub. Date: Sep. 8, 2011

(54) Method And Apparatus For Shape Memory Alloy Bender Actuator

(75) Inventor: Marko Eromãki, Tampere (FI)

(73) Assignee: Nokia Corporation

(21) Appl. No.: 12/716,450

(22) Filed: Mar. 3, 2010

(51) Int. Cl. G03B 3/10; F03G 7/06

(52) U.S. Cl. 396/133; 60/527

(57) ABSTRACT

In accordance with an example embodiment of the present invention, an apparatus is disclosed. The apparatus includes a retention end, a free end, a shape memory alloy (SMA) wire, and a conductive wire. The retention end is configured to be connected to a first member. The free end is configured to be connected to a second member. The SMA wire has a first length. The SMA wire extends between the retention end and the free end. The conductive wire is spaced from the SMA wire. The conductive wire includes a second length substantially equal to the first length when the SMA wire is at a first temperature. The conductive wire extends between the retention end and the free end. The SMA wire is configured to contract when the first temperature is increased. The free end is configured to move in response to the contraction of the SMA wire.

### TECHNICAL FIELD

The invention relates to an electronic device and, more particularly, to a camera lens actuator for an electronic device.

### BACKGROUND

Shape memory alloy (SMA) actuators are arousing technology in the camera area. In the most common application for cameras SMA actuators can be used for autofocus mechanisms. The natural property of the SMA material (such as Nickel-Titanium alloy, for example) is that a change in a length dimension of an SMA member (such as a wire, for example) can be provided when heat is applied to the SMA member. Generally a 50-70 degree Celsius temperature change can contract the SMA wire by 2-5% (along the length). When the SMA wire temperature cools down, it recovers slowly back to the original shape/length.

### SUMMARY

Various aspects of examples of the invention are set out in the claims.

According to a first aspect of the present invention, an apparatus is disclosed. The apparatus includes a retention end, a free end, a shape memory alloy (SMA) wire, and a conductive wire. The retention end is configured to be connected to a first member. The free end is opposite the retention end. The free end is configured to be connected to a second member. At least one of the first and second members is part of a camera module. The shape memory alloy (SMA) wire has a first length. The SMA wire extends between the retention end and the free end. The conductive wire is spaced from the SMA wire. The conductive wire includes a second length. The second length is substantially equal to the first length when the SMA wire is at a first temperature. The conductive wire extends between the retention end and the free end. The SMA wire is configured to contract when the first temperature of the SMA wire is increased to a second temperature. The free end is configured to move in response to the contraction of the SMA wire.

According to a second aspect of the present invention, an apparatus is disclosed. The apparatus includes a camera housing, a lens section, and an actuator. The lens section is movably connected to the camera housing. The actuator includes a retention end and a contact end. The contact end is at the lens section. The actuator includes a shape memory alloy (SMA) member. A first end of the SMA member is at the retention end. A second end of the SMA member is at the contact end. The SMA member is configured to deform when an electrical current is applied to the SMA member. The contact end is configured to exert a force on the lens section in response to the deformation of the SMA member.

According to a third aspect of the present invention, a method is disclosed. A retention portion is provided. The retention portion is configured to be connected to a stationary member. A contact portion is provided opposite the retention portion. The contact portion is configured to be connected to a movable camera lens member. A shape memory alloy (SMA) member is connected between the retention portion and the contact portion. The SMA member includes a first length. A resilient member is connected between the retention portion and the contact portion. The resilient member is substantially parallel to the SMA member. The resilient member includes a second length. The second length is substantially equal to the first length. The SMA member is configured to deform when an electrical current is applied to the SMA member. The contact portion is configured to move in response to the deformation of the SMA member.

According to a fourth aspect of the present invention, a computer program product is disclosed. The computer program product includes a computer-readable medium (such as, a non-transitory computer readable medium, for example) bearing computer program code embodied therein for use with a computer, the computer program code includes the following. Code for applying a first electrical current to a shape memory alloy (SMA) member of a camera lens actuator. The SMA member is configured to transform to a first length when the first electrical current is applied. A first end of the SMA member is configured to remain substantially stationary when the first electrical current is applied. A second opposite end of the SMA member is configured to move a camera lens section to a first position in response to the transformation of the SMA member to the first length. Code for applying a second electrical current to the SMA member. The SMA member is configured to transform to a second length when the second electrical current is applied. The first end of the SMA member is configured to remain substantially stationary when the second electrical current is applied. The second opposite end of the SMA member is configured to move the camera lens section to a second position in response to the transformation of the SMA member to the second length.

### BRIEF DESCRIPTION OF THE DRAWINGS

For a more complete understanding of example embodiments of the present invention, reference is now made to the following descriptions taken in connection with the accompanying drawings in which:

FIG. 1 is a front view of an electronic device incorporating features of the invention;

FIG. 2 is a rear view of the electronic device shown in FIG. 1;

FIG. 3 is a perspective view of a camera module used in the device shown in FIG. 1;

FIG. 4 is another perspective view of the camera module shown in FIG. 3;

FIG. 5 is a perspective view of an actuator used in the device shown in FIG. 1;

FIG. 6 is another perspective view of the actuator shown in FIG. 5;

FIG. 7 is a front view of the actuator shown in FIG. 5;

FIG. 8 is a top plan view of the actuator shown in FIG. 5;

FIG. 9 is a front view of the camera module shown in FIG. 3 with the actuator in one position;

FIG. 10 is a front view of the camera module shown in FIG. 3 with the actuator in another position;

FIG. 11 is a front view of the camera module shown in FIG. 3 with the actuator in yet another position;

FIG. 12 is another perspective view of the camera module shown in FIG. 3;

FIG. 13 is a top plan view of the camera module shown in FIG. 3;

FIG. 14 is a front view of another embodiment of a camera module used in the electronic device shown in FIG. 1;

FIG. 15 is a perspective view of a portion of a manufacturing process of an actuator used in the camera module shown in FIG. 14;

FIG. 16 is a perspective view of another portion of the manufacturing process of the actuator used in the camera module shown in FIG. 14;

FIG. 17 is a front view arm assemblies used in the camera module shown in FIG. 14;

FIG. 18 is a top plan view of one of the arm assemblies shown in FIG. 17;

FIG. 19 is a block diagram of an exemplary method of the electronic device shown in FIG. 1; and

FIG. 20 is a schematic diagram illustrating components of the electronic device shown in FIG. 1.

### DETAILED DESCRIPTION OF THE DRAWINGS

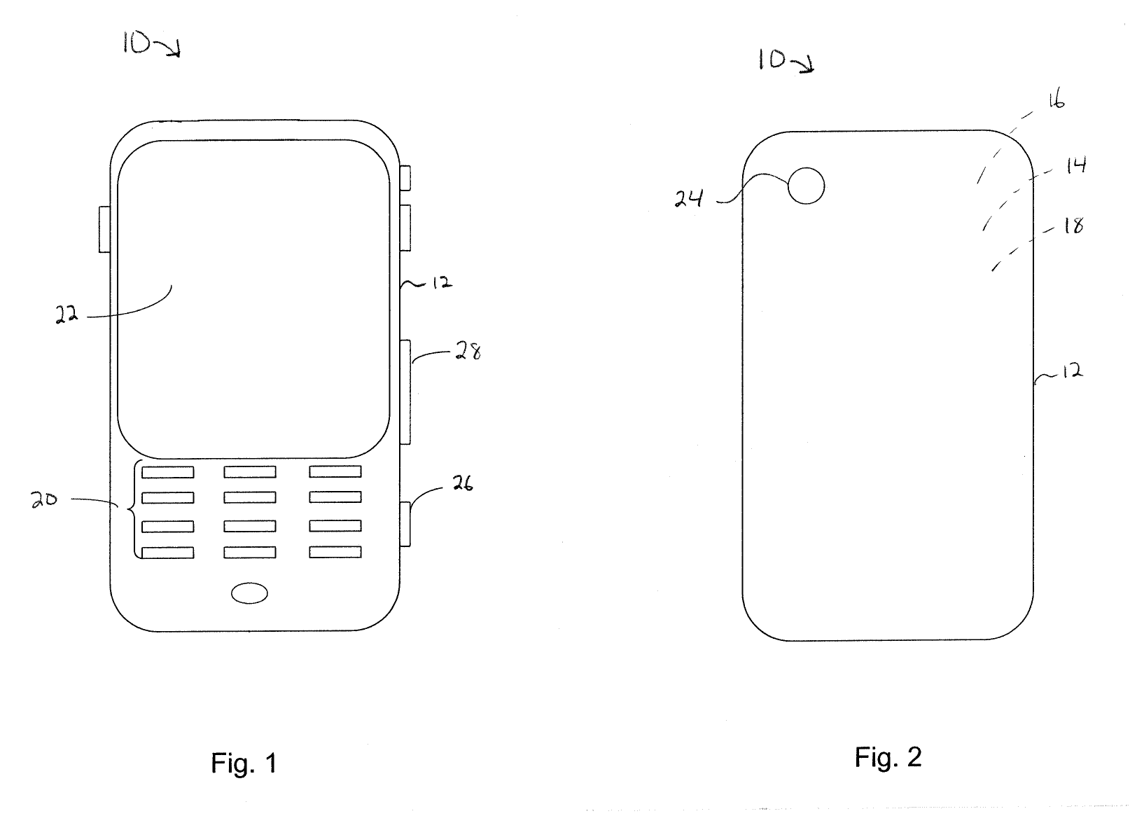

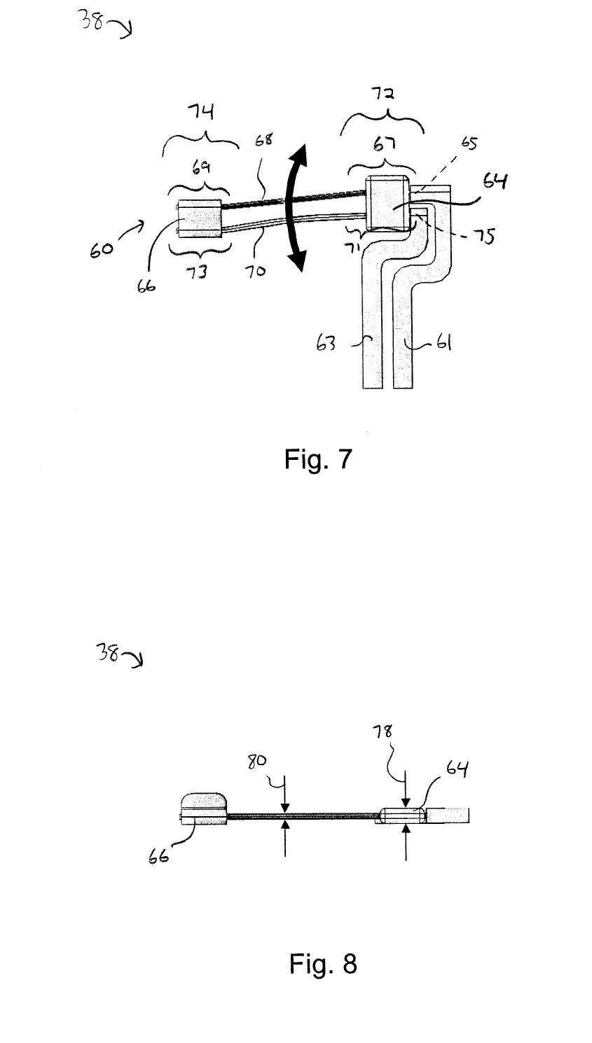

An example embodiment of the present invention and its potential advantages are understood by referring to FIGS. 1 through 20 of the drawings.

Referring to FIG. 1, there is shown a front view of an electronic device 10 incorporating features of the invention. Although the invention will be described with reference to the exemplary embodiments shown in the drawings, it should be understood that the invention can be embodied in many alternate forms of embodiments. In addition, any suitable size, shape or type of elements or materials could be used.

According to one example of the invention shown in FIGS. 1 and 2, the device 10 is a multi-function portable electronic device. However, in alternate embodiments, features of the various embodiments of the invention could be used in any suitable type of portable electronic device such as a mobile phone, a gaming device, a music player, a notebook computer, or a PDA, for example. In addition, as is known in the art, the device 10 can include multiple features or applications such as a camera, a music player, a game player, or an Internet browser, for example. The device 10 generally comprises a housing 12, a transceiver 14 connected to an antenna 16, electronic circuitry 18, such as a controller and a memory for example, within the housing 12, a user input region 20 and a display 22. The display 22 could also form a user input section, such as a touch screen. It should be noted that in alternate embodiments, the device 10 can have any suitable type of features as known in the art.

The electronic device 10 further comprises (a camera 24 which is shown as being rearward facing (for example for capturing images and video for local storage) but may alternatively or additionally be forward facing (for example for video calls). The camera 24 may be controlled by a shutter actuator 26 and optionally by a zoom actuator 28. However, any suitable camera control functions and/or camera user inputs may be provided.

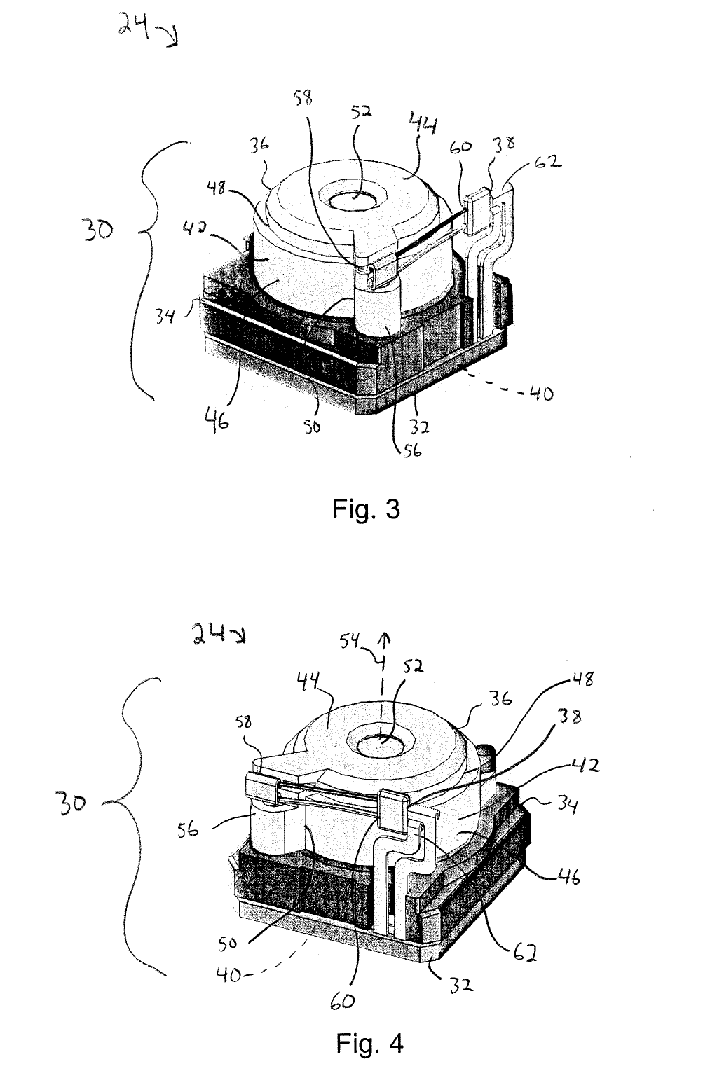

Referring now also to FIGS. 3 and 4, there is shown a camera module 30 of the camera 24. The camera module 30 comprises a base 32, a frame section 34, a camera lens assembly 36, and a shape memory alloy (SMA) bender actuator 38.

The base 32 is suitably sized and shaped to be installed within the housing 12 of the electronic device 10. According to various exemplary embodiments of the invention, the base 32 comprises a printed circuit board 40. However, in alternate embodiments the printed circuit board may be provided in any suitable location.

The frame section 34 is provided on the base 32. The frame section 34 is suitably sized and shaped to allow for mounting of the camera lens assembly 36, and to allow for connection between the camera lens assembly 36 and the printed circuit board 40. The frame section 34 may further comprise a camera sensor package.

The camera lens assembly 36 comprises a camera housing 42 and a lens section 44. The camera housing 42 is a substantially stationary (or static) member mounted on the frame section 34. The camera housing 42 comprises a barrel section 46 having a receiving area 48 and an opening 50.

The lens section 44 is a movable member slidably disposed within the receiving area 48 of the camera housing 42. The movable lens section (or lens holder) 44 supports one or more lens 52 and is suitably sized and shaped to be movably connected to the camera housing 42 at the receiving area 48 such that a movement of the lens section 44 along a z-axis 54 of the camera module 30 may be provided. The movement of the lens section 44 (and the lens 52) along the z-axis 54 allows for an auto focus function of the camera 24 to be performed. An extension portion 56 of the movable lens section 44 extends through the opening 50 and beyond the barrel section 46 of the housing 42. The extension portion 56 also provides a mating area for the actuator 38. In this embodiment, the mating area is provided as a groove 58, however in alternate embodiments any suitable type of mating area may be provided. Although the camera module 30 has been described as having one or more lenses mounted to the movable lens section 44, it should be noted that these configurations are merely provided as non-limiting examples, and any suitable lens configuration may be provided.

The SMA bender actuator 38 comprises an arm assembly 60 and an electrical connection section 62. The actuator 38 introduces a compact and thin standalone autofocus actuator for small camera modules (utilizing low cost shape memory alloy material).

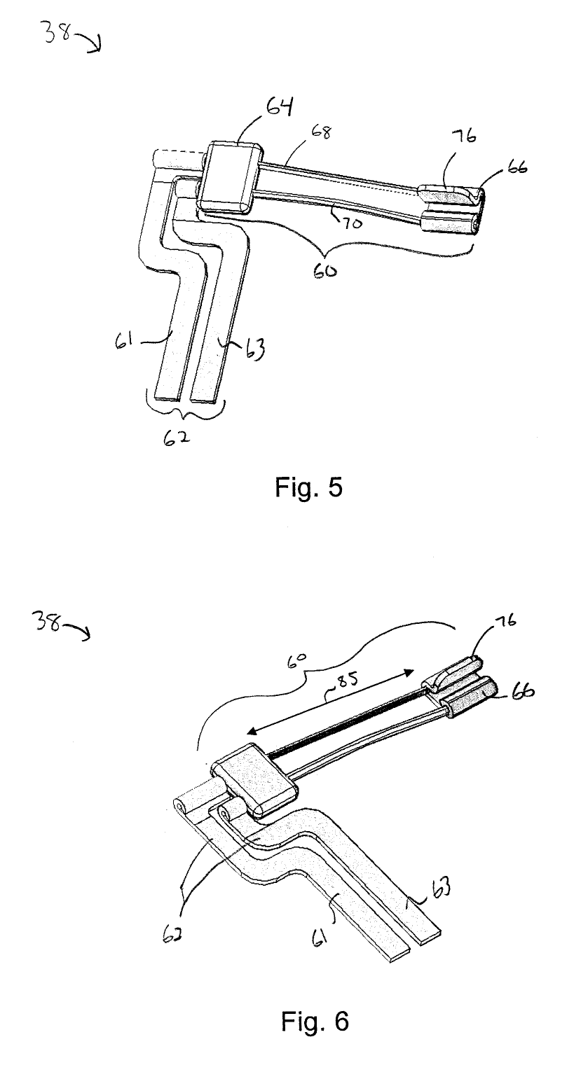

Referring now also to FIGS. 5-8, the arm assembly 60 comprises a retention portion 64, a contact portion 66, an SMA member 68, and a conductive member 70.

The retention portion 64, which may be a retention member for example, is suitably sized and shaped to receive ends 67, 71 of the SMA member 68 and the conductive member 70. The retention member (or spacer element) 64 may comprise a molded or cast material, such as plastic for example. However, any suitable electrically non-conductive material may be provided. The retention member 64 provides for mechanical retention between the SMA member 68 and the conductive spring member 70 at a retention end 72 of the arm assembly 60. According to certain embodiments of the invention, the retention member 64 has no electrical function.

The contact portion 66, which may be a contact member for example, is suitably sized and shaped to receive ends 69, 73 of the SMA member 68 and the conductive member 70. Additionally, the contact member 66 comprises a conductive material, such as sheet metal for example, and is configured to be connected to the SMA member 68 and the conductive member 70, such as by crimping for example. It should be noted that sheet metal is not required, and in alternate embodiments the contact member 66 may comprise any suitable electrically conductive material. The crimped connection provides an electrical connection between the SMA member 68 and the conductive member 70 at a contact end 74 of the arm assembly 60. However, it should be noted that crimping is not required, and any suitable connection and/or material allowing for electrical connection between the SMA member and the conductive member may be provided. The contact member 66 further comprises a lip portion 76. The lip portion 76 is configured to be engageable with the mating area 58 of the movable lens section 44.

The SMA member 68 comprises a shape memory alloy (SMA) material formed in a general wire (or slender rod) shape. The SMA material may comprise a nickel-titanium alloy for example, however any suitable type of shape memory alloy may be provided. The SMA wire 68 extends between the retention member 64 and the contact member 66 wherein the end 67 of the SMA wire 68 is at the retention member 64 and the end 69 of the SMA wire 68 is at the contact member 66. Additionally, a portion 65 of the end 67 extends beyond the retention member 64.

The conductive member 70 comprises a conductive material formed in a general wire (or slender rod) shape. The conductive material may comprise any suitable type of electrically conductive material, such as steel for example, which further forms a spring, or resilient, member. The conductive wire 70 extends between the retention member 64 and the contact member 66 wherein the end 71 of the conductive wire 70 is at the retention member 64 and the end 73 of the conductive wire 70 is at the contact member 66. Additionally, a portion 75 of the end 71 extends beyond the retention member 64.

The SMA wire 68 and the conductive wire 70 comprise substantially the same length. Additionally, the SMA wire 68 and the conductive wire 70 extend between the retention member 64 and the contact member 66 such that they are spaced from each other in a substantially parallel fashion.

The electrical connection section 62 comprises a first connection member 61 and a second connection member 63. The first and second connection members 61, 63 may each be formed from a sheet metal material, for example. The connection members 61, 63 extend between the ends of the wires 68, 70 (at the portions 65, 75 extending beyond the retention member 64) and the printed circuit board 40. The connection members 61, 63 may be crimped onto the portions 65, 75, however, it should be noted that any suitable connection between the connection members 61, 63 and the wires 68, 70 may be provided. The connection members 61, 63 are also connected to the printed circuit board 40 to supply electricity through the sheet metal arms 61, 63. This allows for an electrical circuit to be formed through the connection member 61, the SMA wire 68, the contact member 66, the conductive wire 70, and the connection member 63.

Further, this provides for the arm assembly 60 to extend from the electrical connection section 62 in a general cantilever fashion, such that the retention end is substantially fixed (at the electrical connection section 62) and the contact end 74 forms a free end. When the actuator 38 is energized, the arm assembly 60 is configured to bend to provide a force between the contact portion 66 and the movable lens section 44.

According to various exemplary embodiments of the invention, the actuator 38 comprises a thin profile which provides an improved configuration for camera integration. For example (as best seen in FIG. 8), the actuator comprises about a 0.5 mm thickness in the area of the retention member 64, and about a 0.1 mm thickness in the area 80 of the wires 68, 70 (where it is closest to the lenses).

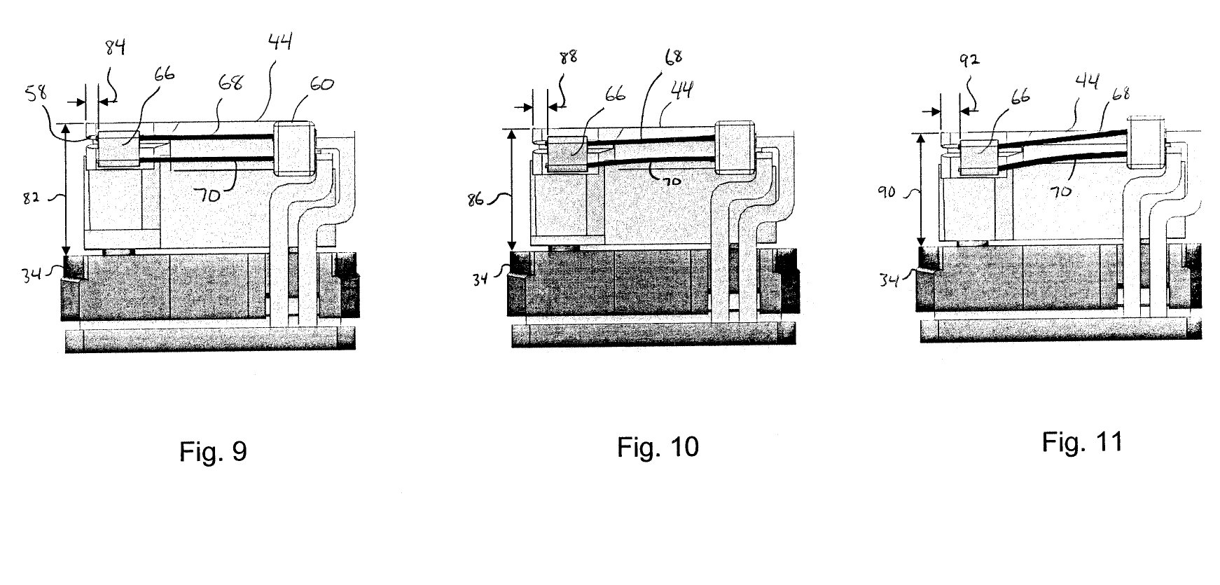

According to various exemplary embodiments of the invention, a bending arm mechanism is provided for generating a long movement from an SMA wire which is only generally capable of achieving very small contraction (along a length for example). According to one example of the invention as shown in FIGS. 9-11, the SMA wire 68 and normal spring wire 70 are provided with substantially equal lengths, such that both ends 67, 69, 71, 73 of the wires 68, 70 are fixed together at the retention end 72 and the free end 74 of the arm assembly 60.

When at a predetermined temperature, such as room temperature (about 20 degrees Celsius) for example, the wires 68, 70 are substantially straight, which allows the arm assembly 60 to extend in a substantially straight fashion (see FIG. 9). At this temperature (and corresponding actuator position) the movable lens section is at one of a plurality of auto focus positions, wherein the top end of the lens section 44 is spaced from the frame section 34 at a distance 82, and wherein the contact member 66 is spaced from an end of the groove section 58 at a distance 84.

In order to change the lens position for auto focus operation, an increased temperature may be applied to the SMA wire 68. The longer the wires are, the longer the movement that will occur. For autofocus purposes, the movement may generally be about 200-300 um, so fairly short wire lengths can be used. According to various exemplary embodiments of the invention, a current may be applied (or increased) to the SMA member 68 in order to increase the temperature. However, it should be noted that in alternate embodiments, any suitable method or configuration allowing for increasing/decreasing the temperature of the SMA wire may be provided.

When the SMA wire 68 is heated with current, the SMA wire 68 transforms along a length 85 of the SMA wire. In particular, the SMA wire 68 contracts with the increase in temperature. By forcing the SMA wire 68 to contract by heating it with the electrical current, this decreases a distance between the contact member 66 and the retention member 64. The decreasing of the distance between the members 66, 64 forces the wire spring 70 to bend upwards. It should be noted that any suitable wire spring bending direction may be provided, for example in alternate examples of the invention, the wire spring may bend downwards.

When at a first increased temperature (achieved by providing a predetermined current to the SMA wire 68), the arm assembly 60 of the actuator 38 begins to bend in response to the deformation of the SMA wire 68 and the bending of the conductive wire 70 (see FIG. 10). The bending of the arm assembly 60 moves the contact member in a (downward) direction towards the frame section 34. With the lip portion 76 of the contact member 66 connected to the groove 58 of the movable lens section 44, the downward movement of the contact member 66 applies a force to the movable lens section 44. The force applied to the lens section 44 provides for moving the lens section 44 corresponding to the auto focus function. At the first increased temperature (and corresponding actuator position) the movable lens section 44 is moved to another one of the plurality of auto focus positions, wherein the top end of the lens section 44 is spaced from the frame section at a distance 86 (wherein the distance 86 is less than the distance 82), and wherein the contact member 66 is spaced from an end of the groove section 58 at a distance 88 (wherein the distance 88 is greater than the distance 84).

When another predetermined current is applied to the SMA wire 38, a second increased temperature of the SMA wire is provided. At this second increased temperature, the arm assembly 60 of the actuator 38 continues to bend in response to the further deformation of the SMA wire 68 and the further bending of the conductive wire 70 (see FIG. 11). The further bending of the arm assembly 60 continues to move the contact member 66 in the (downward) direction towards the frame section 34. With the lip portion 76 of the contact member 66 connected to the groove 58 of the movable lens section 44, the continued downward movement of the contact member continues to apply the force to the movable lens section 44. The force applied to the lens section 44 provides for moving the lens section 44 corresponding to the auto focus function. At the second increased temperature (and corresponding actuator position) the movable lens section 44 is at yet another one of the plurality of auto focus positions, wherein the top end of the lens section 44 is spaced from the frame section 34 at a distance 90 (wherein the distance 90 is less than the distance 86), and wherein the contact member 66 is spaced from an end of the groove section 58 at a distance (wherein the distance 92 is greater than the distance 88).

When the current supply to the circuit is stopped or reduced, this allows the SMA wire 68 to cool to a reduced temperature. As the SMA wire 68 returns to the reduced temperature, such as room temperature for example, the length deforms back to a length substantially equal to the length of the conductive wire 70. As the SMA wire 68 extends, the bias spring 70 straightens. This causes the arm assembly 60 to straighten. As the arm assembly straightens 60, the contact member 66 applies an upward force to the lens section 44 and moves the movable lens section 44 to the position shown in FIG. 9.

Technical effects of any one or more of the exemplary embodiments provide an improved actuator when compared to conventional configurations having a discrete spring. For example, the counterforce spring (or conductive wire) provides an integrated spring for a recovery function, wherein the conductive wire can help extend the SMA wire to its original length during the cooling stage.

The SMA wire 68 can provide a very high force during the contraction stage and therefore, a small wire thickness (such as about a thickness of human hair, for example) is generally sufficient. With such a thin wire, the cooling period happens very rapidly, such as in about a certain number of milliseconds. During the cooling stage, the wire is extended to substantially its original length with the help of the wire spring in the system. During this relaxation phase the wire may not provide any force, ant the spring generally performs the movement to the opposite direction.

It should be noted that although FIGS. 9-11 illustrate the actuator and the movable lens section in three different positions, it should be noted that these positions are merely exemplary and any number of suitable auto focus positions may be provided.

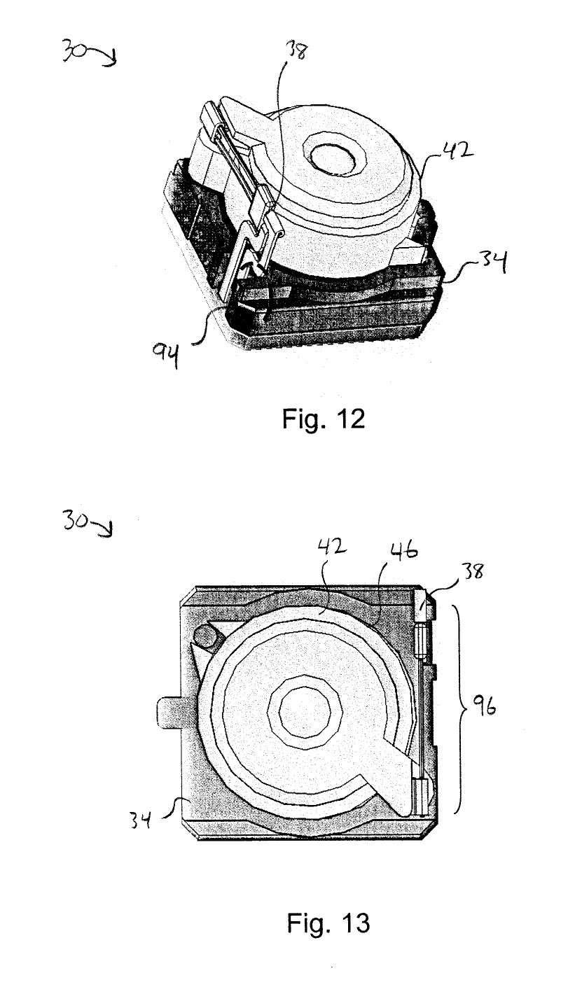

Technical effects of any one or more of the exemplary embodiments provide improvements when compared to conventional configurations. Referring now also to FIGS. 12 and 13, the actuator 38 provides a thin and compact shape which generally does not interfere with locking features for surface mounted device (SMD) sockets on the frame section 34 (see outlined area 94 of FIG. 12). Whereas, conventional configurations generally have a critical wire shape very close to these SMD sockets.

Additional technical effects of any one or more of the exemplary embodiments provide for the lens barrel size to generally not be affected (limited) by the actuator shape, as the actuator consumes space on only one side 96 of the module 30 (whereas conventional configurations generally consumes space on two sides of the module). Additionally, as the actuator does not interfere with the lens barrel, this enables to utilize a large size for the lens. This is beneficial as high end optics generally use larger lens.

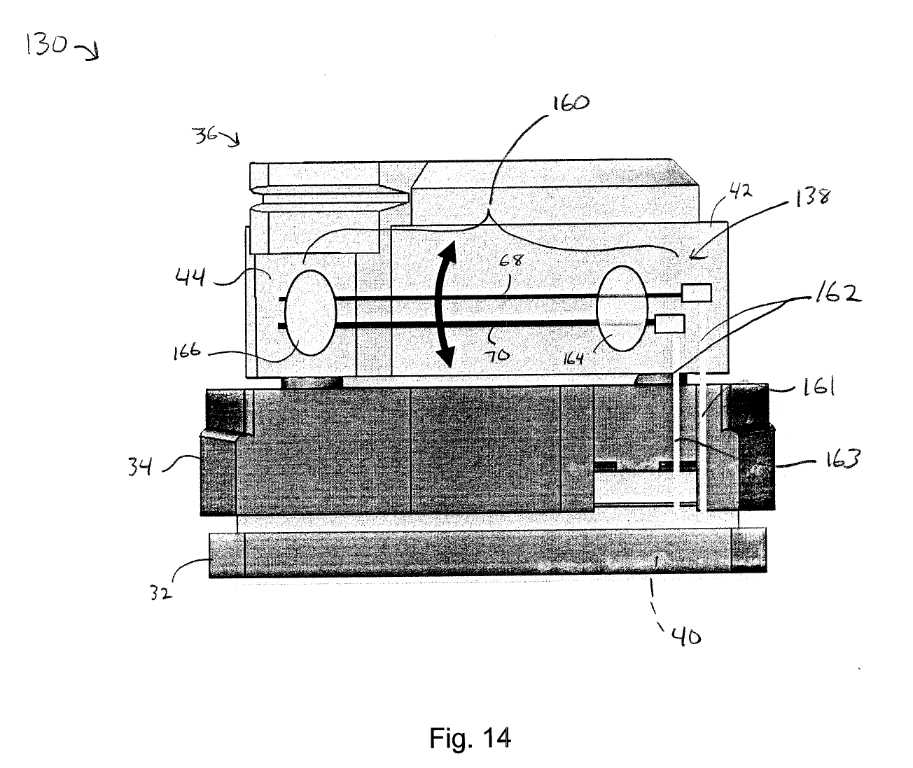

Referring now also to FIG. 14, there is shown a camera module 130 in accordance with another embodiment of the invention. Similar to the camera module 30, the camera module 130 comprises the base 32, the frame section 34, the camera lens assembly 36, and an SMA bender actuator 138. Also similar to the camera module 30, the SMA bender actuator 138 comprises an arm assembly 160 and an electrical connection section 162.

The arm assembly 160 is similar to the arm assembly 60, however in this embodiment the arm assembly 160 comprises adhesive sections at the retention portion 164 and the contact portion 166. Each of the adhesive sections comprises a drop (or drops) of and adhesive, or glue, to connect the wires 68, 70 together at the retention portion 164 and the contact portion 166.

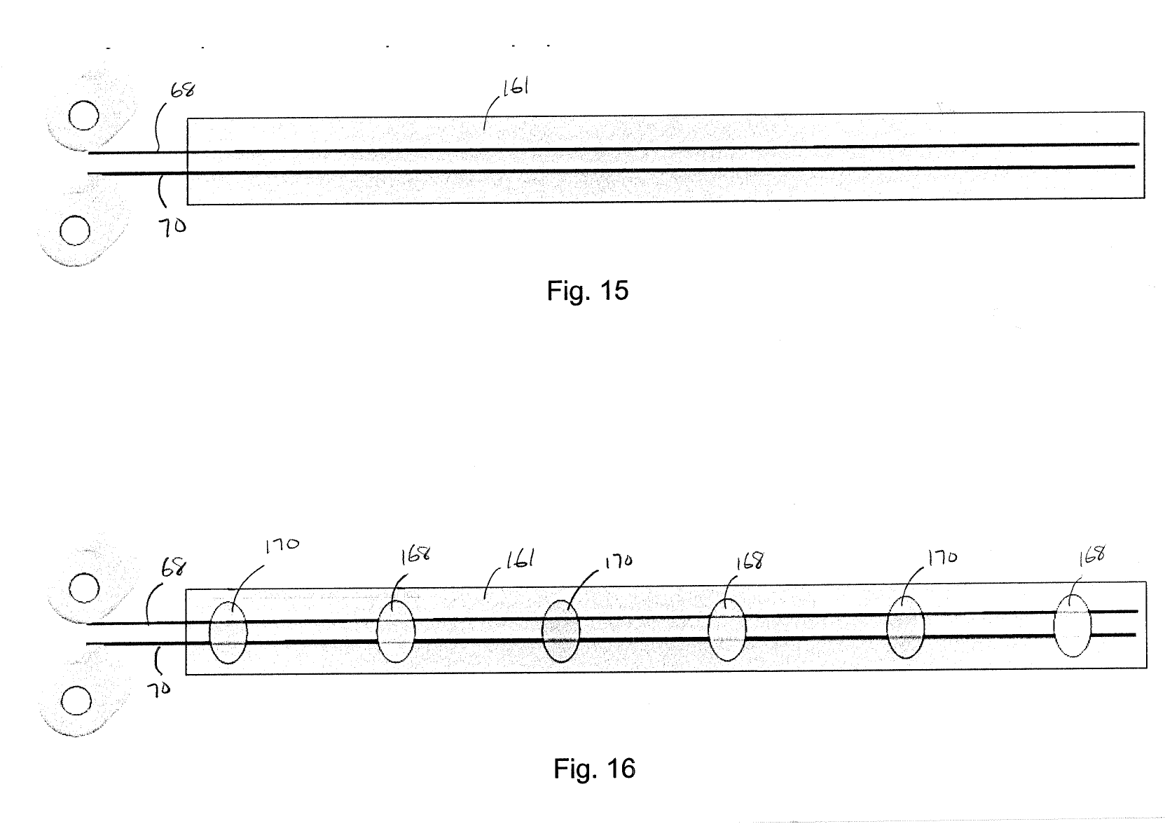

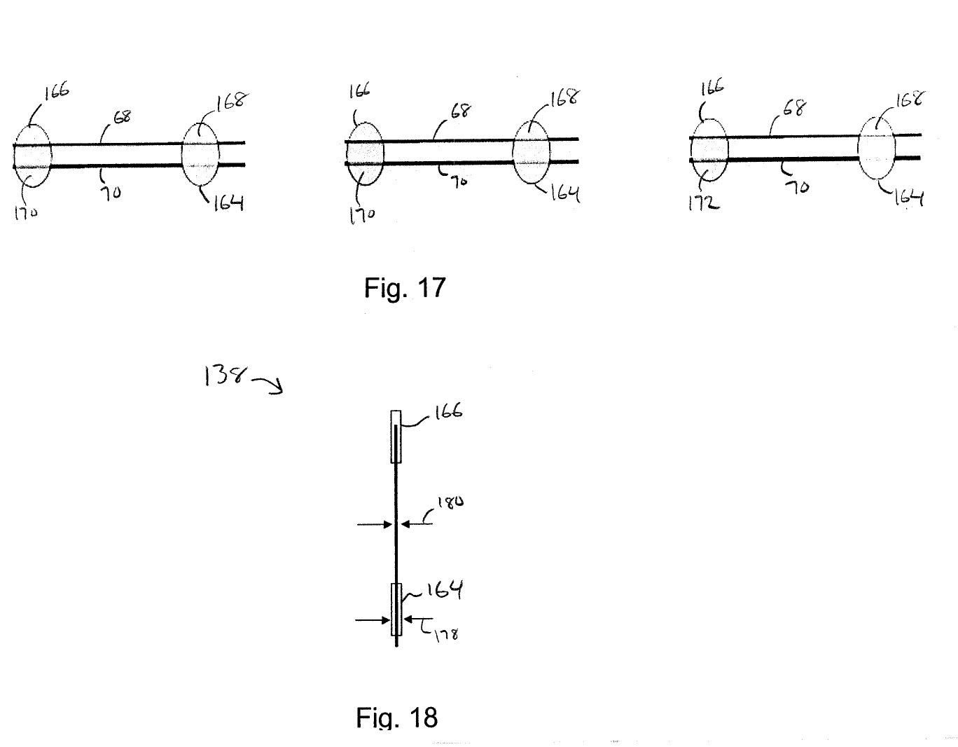

Referring now also to FIGS. 15-17, the actuator provides a very low cost example using the bending arm principle. In order to assemble or manufacture the assembly arm 160, both wire feedstock (the SMA wire 68 and the steel wire 70) are rolled out on to a piece of tape 161. The tape 161 may be any suitable type of tape such as a thin adhesive tape, for example. The adhesive tape 161 holds the SMA wire 68 and the conductive wire 70 in place and at a certain distance, and fixes the wires 68, 70 for the next assembly stage. In that stage drops of adhesive are dispensed at certain locations (proximate the retention end and the contact end) to connect the wires 68, 70 together. One adhesive 168 comprises an epoxy type non-conductive glue. The non-conductive glue 168 is provided at the retention portion 164 to hold the wires 68, 70 together and provide a similar function as that of the retention member 64. The other adhesive 170 comprises a conductive type of glue, such as a silver paste, for example. The conductive glue 170 is provided at the contact section 166 to create an electrical bridge between the wires 68, 70 (which provides a similar function as that of the contact member 66). After the adhesives 168, 170 are cured, the double-wire assemblies are singulated and the carrier tape removed/trimmed (see FIG. 17). Then, by crimping sheet metal electrodes 161, 163 at the open ends of the wires (see FIG. 14), the actuator 138 is ready to be integrated inside the camera module 130. By attaching one side of the double-wire element to moving lens group (or section) 44 and the other one to static camera housing 42, it is able to move the lenses up and down when current is applied (as described above for the actuator 38). Additionally, this process can be automatized.

The electrical connection section 162 is similar to the electrical connection section 62. The electrical connection section 162 comprises the first connection member 161 and the second connection member 163. The first and second connection members 161, 163 may each be formed from a sheet metal material, for example. The connection members extend between the ends of the wires 68, 70 (at the portions extending beyond the retention portion) and the printed circuit board 40. The connection members 161, 163 may be crimped onto the portions (as described above), however, it should be noted that any suitable connection between the connection members and the wires may be provided. The connection members are also connected to the printed circuit board to supply electricity through sheet metal arms. This allows for an electrical circuit to be formed through the connection member 161, the SMA wire 68, the adhesive contact section 166, the conductive wire 70, and the connection member 163.

According to various exemplary embodiments of the invention, the actuator 138 comprises a thin profile which provides an improved configuration for camera integration. For example (as best seen in FIG. 18), the actuator comprises about a 0.5 mm thickness in the area 178 of the adhesive section 164, and about a 0.1 mm thickness in the area 180 of the wires 68, 70. The resulted actuator has very thin form factor.

Technical effects of any one or more of the exemplary embodiments provide a simple actuator design for autofocus cameras which utilizes shape memory alloy wire (SMA). The SMA material is configured such that it can change shape (along the length) when heat is applied. Deformation is generally about 2-5% and it occurs at temperature range of about 50-70 degrees Celsius. For a reasonable autofocus stroke, this level of deformation is generally too small. Various exemplary embodiments of the invention provide an improved mechanism is between the moving lens assembly and the wire. According to some examples of the invention, a simple and compact, especially thin, actuator structure for generating the required movement is provided which includes benefits in manufacturability, modularity, functional performance and cost when compared to conventional configurations.

Additional technical effects of any one or more of the exemplary embodiments provide significant improvements when compared to conventional configurations which have a discrete structure which is heavily involved with the camera assembly process (which may affect negatively to part designs). According to various exemplary embodiments of the invention a configuration is provided that does not interfere with the internal space used by the camera optics, but allows to maximize the size of lenses. It also avoids interfering with the critical integration features on the camera module which are used to fix the camera to the SMD socket. Additionally, since there are no electric or magnetic fields involved, electromagnetic interference/magnetic emissions are none. This means that there are no shielding (such as electroplating, for example) requirements for the camera module with respect to the actuator. Furthermore, silent operation of the actuator is beneficial when continuous autofocus is operating during video recording. Yet further, a simple structure using wire and sheet metal and plastic materials results in a cost effective end result, and the assembly structure is possible to be automized (which is generally difficult with the conventional configurations).

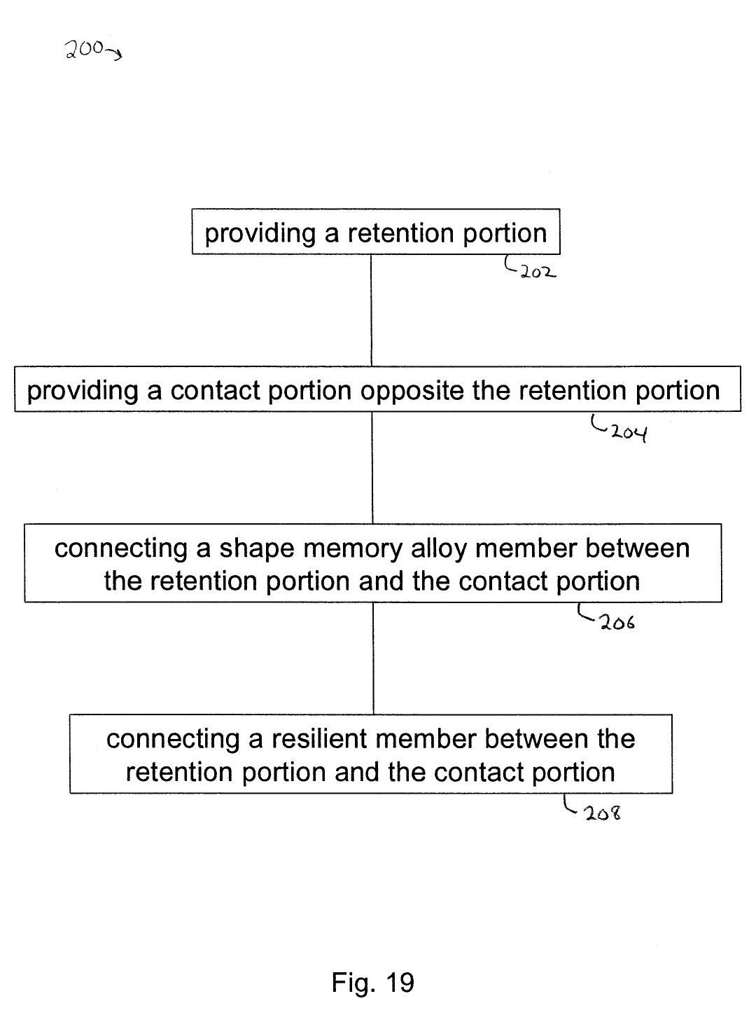

FIG. 19 illustrates a method 200. The method 200 includes providing a retention portion, wherein the retention portion is configured to be connected to a stationary member (at block 202). Providing a contact portion opposite the retention portion, wherein the contact portion is configured to be connected to a movable camera lens member (at block 204). Connecting a shape memory alloy (SMA) member between the retention portion and the contact portion, wherein the SMA member comprises a first length (at block 206). Connecting a resilient member between the retention portion and the contact portion, wherein the resilient member is substantially parallel to the SMA member, wherein the resilient member comprises a second length, and wherein the second length is substantially equal to the first length (at block 208). Wherein the SMA member is configured to deform when an electrical current is applied to the SMA member, and wherein the contact portion is configured to move in response to the deformation of the SMA member. It should be noted that the illustration of a particular order of the blocks does not necessarily imply that there is a required or preferred order for the blocks and the order and arrangement of the blocks may be varied. Furthermore it may be possible for some blocks to be omitted.

It should be noted that although the figures and description have been provided with the conductive spring member shown as bending up when the SMA member contracts, any suitable bending configuration may be provided. Additionally, while various exemplary embodiments of the invention have been described in connection with a camera module, one skilled in the art will appreciate that the various exemplary embodiments are not necessarily so limited and that the SMA bender actuator may be provided on any suitable electronic device module having movable members.

It should be understood that components of the invention can be operationally coupled or connected and that any number or combination of intervening elements can exist (including no intervening elements). The connections can be direct or indirect and additionally there can merely be a functional relationship between components.

As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

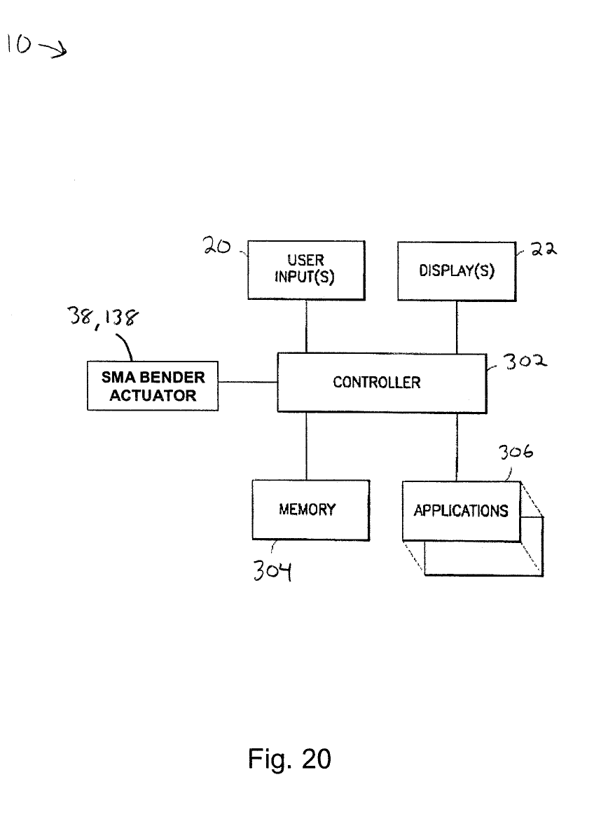

Referring now also to FIG. 20, the device 10, generally comprises a controller 302 such as a microprocessor for example. The electronic circuitry includes a memory 304 coupled to the controller 302, such as on a printed circuit board for example. The memory could include multiple memories including removable memory modules for example. The device has applications 306, such as software, which the user can use. The applications can include, for example, a telephone application, an Internet browsing application, a game playing application, a digital camera application, a map/gps application, etc. These are only some examples and should not be considered as limiting. One or more user inputs 20 are coupled to the controller 302 and one or more displays 22 are coupled to the controller 302. The bender actuator 38, 138 is also coupled to the controller 302. The device 10 may be programmed to automatically perform auto focus lens operations. However, in an alternate embodiment, this might not be automatic. The user might need to actively perform the auto focus lens operations.

Embodiments of the present invention may be implemented in software, hardware, application logic or a combination of software, hardware and application logic. The software, application logic and/or hardware may reside on the memory 304, another memory of the device, or any other suitable location. If desired, part of the software, application logic and/or hardware may reside on the memory 304, part of the software, application logic and/or hardware may reside on the another memory of the device, and part of the software, application logic and/or hardware may reside on the any other suitable location. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 20. A computer-readable medium may comprise a computer-readable storage medium that may be any media or means that can contain or store the instructions for use by or in connection with an instruction execution system, apparatus, or device, such as a computer.

According to one example of the invention, a program storage device readable by a machine, tangibly embodying a program of instructions executable by the machine for performing auto focus operations is disclosed. For example the device may comprise code for applying a first electrical current to a shape memory alloy (SMA) member of a camera lens actuator, wherein the SMA member is configured to transform to a first length when the first electrical current is applied, wherein a first end of the SMA member is configured to remain substantially stationary when the first electrical current is applied, and wherein a second opposite end of the SMA member is configured to move a camera lens section to a first position in response to the transformation of the SMA member to the first length.

For example the device may further comprise code for applying a second electrical current to the SMA member, wherein the SMA member is configured to transform to a second length when the second electrical current is applied, wherein the first end of the SMA member is configured to remain substantially stationary when the second electrical current is applied, and wherein the second opposite end of the SMA member is configured to move the camera lens section to a second position in response to the transformation of the SMA member to the second length.

If desired, the different functions discussed herein may be performed in a different order and/or concurrently with each other. Furthermore, if desired, one or more of the above-described functions may be optional or may be combined.

Without in any way limiting the scope, interpretation, or application of the claims appearing below, various technical effects of one or more of the example embodiments disclosed herein are: The SMA actuator can be constructed as a standalone unit and the assembly procedure be separated from the camera assembly process. Being a standalone unit, it has modularity, and thus the same part can be used in several devices. This additionally provides for easy-integration to the camera, wherein the unit does not need much supportive camera mechanics around it to work. The extremely compact size of the core actuator provides a suitable form factor for small camera modules. For example, the smaller outline shape with thin and flat form factor provides an actuator having a thickness of about less than 0.5 mm. Furthermore, a long stroke can be achieved since the SMA wire is operating through a bending mechanism, wherein when compared to conventional configurations, only 50% of the wire length is needed to create a longer z-direction movement.

Further technical effects of one or more of the example embodiments disclosed herein are: providing simple materials and structure to manufacture the actuator, wherein wire and sheet metal parts can be cut and crimped together, or adhesive/moulding operations can be performed (provided manufacturability benefits and cost benefits). The counterforce spring is integrated within the arm assembly, such that no extra parts are needed. Additionally, there are no external contacts to the SMA wire on the contraction area that could cause a change in its heat profile (thus providing stable operation). Furthermore, low power consumption and low voltage operation may be provided such as, about 1-3 volts and about 20-40 mA, for example. Low power consumption improves continuous autofocus operations (which can be an essential feature in high definition videos, for example).

Yet further technical effects of one or more of the example embodiments disclosed herein provide for a configuration that does not render the camera to be unusable in extreme hot environments. For example, the actuator mechanism allows the device to work in hot conditions when the SMA may no longer transform in length (such as contracting or returning to an original length), such as when temperatures reach above about 75 degrees Celsius. This improved operability may be provided by configuring the bending arm to be set to settle in Tele mode instead of normal Macro, for example. Whereas, conventional configurations may suffer from not functioning in hot temperatures causing the lens module to be stuck in Macro mode due to the compensation spring used on top of the module. However, it should be noted that the basic SMA material can have a hysteresis effect.

Technical effects of any one or more of the exemplary embodiments provide a simpler overall structure with less total parts, such as having the counterforce spring integrated to the bending arm design, for example. The bending arm principle creates a long movement from the short shrinkage of the SMA wire, and connections to the electrical terminals and electrical circuit through the parts are provided. This can provide a cost benefit due to structural simplicity when compared to existing conventional configurations.

According to one example of the invention, an apparatus is disclosed. The apparatus includes a retention end, a free end, a shape memory alloy wire, and a conductive wire. The retention end is configured to be connected to a first member. The free end is opposite the retention end. The free end is configured to be connected to a second member. At least one of the first and second members is part of a camera module. The SMA wire has a first length. The SMA wire extends between the retention end and the free end. The conductive wire is spaced from the SMA wire. The conductive wire comprises a second length. The second length is substantially equal to the first length when the SMA wire is at a first temperature. The conductive wire extends between the retention end and the free end. The SMA wire is configured to contract when the first temperature of the SMA wire is increased to a second temperature. The free end is configured to move in response to the contraction of the SMA wire.

According to another example of the invention, an apparatus is disclosed. The apparatus includes a camera housing, a lens section, and an actuator. The lens section is movably connected to the camera housing. The actuator comprises a retention end and a contact end. The contact end is at the lens section. The actuator comprises a shape memory alloy (SMA) member. A first end of the SMA member is at the retention end. A second end of the SMA member is at the contact end. The SMA member is configured to deform when an electrical current is applied to the SMA member. The contact end is configured to exert a force on the lens section in response to the deformation of the SMA member.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
a retention end configured to be connected to a first member;
a free end opposite the retention end, wherein the free end is configured to be connected to a second member, wherein at least one of the first and second members is part of a camera module;
a shape memory alloy wire having a first length, wherein the shape memory alloy wire extends between the retention end and the free end; and
a conductive wire spaced from the shape memory alloy wire, wherein the conductive wire comprises a second length, wherein the second length is substantially equal to the first length when the shape memory alloy wire is at a first temperature, and wherein the conductive wire extends between the retention end and the free end;
wherein the shape memory alloy wire is configured to contract when the first temperature of the shape memory alloy wire is increased to a second temperature, and wherein the free end is configured to move in response to the contraction of the shape memory alloy wire.

2. An apparatus as in claim 1, further comprising an arm assembly, wherein the arm assembly comprises the shape memory alloy wire and the conductive wire, and wherein the arm assembly is configured to bend in response to the contraction of the shape memory alloy wire.

3. An apparatus as in claim 1 wherein the shape memory alloy wire is configured to contract when an electrical current is applied to the shape memory alloy wire.

4. An apparatus as in claim 1 wherein the shape memory alloy wire is electrically connected to the conductive wire.

5. An apparatus as in claim 1 wherein the conductive wire is configured to move the free end to a predetermined position when the temperature of the shape memory alloy wire is increased to greater than about 75 degrees Celsius.

6. An apparatus as in claim 1, further comprising a contact member, wherein the contact member is at the free end, and wherein the contact member is attached to the shape memory alloy wire and the conductive wire.

7. An apparatus as in claim 1, further comprising an adhesive section, wherein the adhesive section is at the free end, and wherein the adhesive section is attached to the shape memory alloy wire and the conductive wire.

8. A module comprising:
a camera housing;
a lens section movably connected to the camera housing; and an apparatus as in claim 1, wherein the retention end is connected to the camera housing, and wherein the free end is connected to the lens section.

9. An apparatus, comprising:
a camera housing;
a lens section movably connected to the camera housing; and
an actuator comprising a retention end and a contact end, wherein the contact end is at the lens section, wherein the actuator comprises a shape memory alloy member, wherein a first end of the shape memory alloy member is at the retention end, wherein a second end of the shape memory alloy member is at the contact end, wherein the shape memory alloy member is configured to deform when an electrical current is applied to the shape memory alloy member, and wherein the contact end is configured to exert a force on the lens section in response to the deformation of the shape memory alloy member.

10. An apparatus as in claim 9 wherein the actuator comprises an arm assembly, wherein the arm assembly comprises the retention end, the contact end, and the shape memory alloy member, and wherein the arm assembly is configured to bend in response to the deformation of the shape memory alloy member.

11. An apparatus as in claim 9, 10, further comprising a conductor, wherein one end of the conductor is connected to the retention end, and wherein another end of the conductor is connected to a printed circuit board.

12. An apparatus as in claim 9 further comprising a retention member, a contact member, and a conductive member, wherein the shape memory alloy member extends between the retention member and the contact member, wherein the conductive member is electrically connected to the shape memory alloy member through the contact member, and wherein the conductive member is spaced from the shape memory alloy member.

13. An apparatus as in claim 12 wherein the conductive member comprises a spring member configured to exert a force on the lens section when the shape memory alloy member transforms to an extended length.

14. An apparatus as in claim 9 further comprising an adhesive retention section, an adhesive contact section, and a conductive member, wherein the shape memory alloy member extends between the adhesive retention section and the adhesive contact section, wherein the conductive member is electrically connected to the shape memory alloy member through the adhesive contact section, and wherein the conductive member is spaced from the shape memory alloy member.

15. An apparatus as in claim 9 wherein the apparatus comprises a camera module used in a mobile phone.

16. A method, comprising:
providing a retention portion, wherein the retention portion is configured to be connected to a stationary member;
providing a contact portion opposite the retention portion, wherein the contact portion is configured to be connected to a movable camera lens member;
connecting a shape memory alloy member between the retention portion and the contact portion, wherein the shape memory alloy member comprises a first length; and
connecting a resilient member between the retention portion and the contact portion, wherein the resilient member is substantially parallel to the shape memory alloy member, wherein the resilient member comprises a second length, and wherein the second length is substantially equal to the first length;
wherein the shape memory alloy member is configured to deform when an electrical current is applied to the shape memory alloy member, and wherein the contact portion is configured to move in response to the deformation of the shape memory alloy member.

17. A method as in claim 16 wherein the retention portion, the contact portion, the shape memory alloy member, and the resilient member form an arm assembly, wherein the arm assembly is configured to bend in response to the deformation of the shape memory alloy member.

18. A method as in claim 16 wherein the retention portion comprises a retention member formed from a polymer material, and wherein the contact portion comprises a contact member formed from a conductive material.

19. A method as in claim 16 wherein the retention portion comprises an adhesive retention section comprising a non-conductive adhesive, and wherein the contact portion comprises an adhesive contact section comprising a conductive adhesive.

20. A computer program product comprising a computer-readable medium bearing computer program code embodied therein for use with a computer, the computer program code comprising:
code for applying a first electrical current to a shape memory alloy member of a camera lens actuator, wherein the shape memory alloy member is configured to transform to a first length when the first electrical current is applied, wherein a first end of the shape memory alloy member is configured to remain substantially stationary when the first electrical current is applied, and wherein a second opposite end of the shape memory alloy member is configured to move a camera lens section to a first position in response to the transformation of the shape memory alloy member to the first length; and
code for applying a second electrical current to the shape memory alloy member, wherein the shape memory alloy member is configured to transform to a second length when the second electrical current is applied, wherein the first end of the shape memory alloy member is configured to remain substantially stationary when the second electrical current is applied, and wherein the second opposite end of the shape memory alloy member is configured to move the camera lens section to a second position in response to the transformation of the shape memory alloy member to the second length.

21. A computer program product as in claim 20 further comprising code for reducing the first or second electrical current, wherein the reduced current provides a temperature configured to transform the shape memory alloy member to a length substantially equal to a length of an adjacently disposed conductive member.
